(19) United States
(12) Patent Application Publication
(10) Pub. No.: US 2020/0324227 A1
(43) Pub. Date: Oct. 15, 2020

(54) Filters Having a Plurality of Openings

(71) Applicants: James R. Munson, Flemington, NJ (US); James Stryker, Pittstown, NJ (US); George E. Hicks, Elizabeth, IN (US); Dennis N. Malaba, Uniontown, OH (US)

(72) Inventors: James R. Munson, Flemington, NJ (US); James Stryker, Pittstown, NJ (US); George E. Hicks, Elizabeth, IN (US); Dennis N. Malaba, Uniontown, OH (US)

(21) Appl. No.: 16/825,852

(22) Filed: Mar. 20, 2020

Related U.S. Application Data
(60) Provisional application No. 62/831,889, filed on Apr. 10, 2019.

(51) Int. Cl. B01D 29/03; B01D 39/18

(52) U.S. Cl. CPC B01D 29/03; B01D 2239/0407; B01D 39/18

(57) ABSTRACT

A medium for filtering a fluid, such as cooking oil, unrefined edible oil, biodiesel fuel, and fruit-based and vegetable-based beverages, which comprises a top filter panel and a bottom filter panel. Each of the top filter panel and the bottom filter panel has a planar surface, and the top filter panel is in contact with the bottom filter panel. The top panel has at least one opening in communication with the bottom panel such that the filter medium provides for controlled flow of the fluid through the top filter panel and the bottom filter panel. The top filter panel is designed to provide longer filter life before plugging or fouling of the filter.

This application claims priority based on provisional Application Ser. No. 62/831,889, filed Apr. 10, 2019, the contents of which are incorporated by reference in their entirety.

This invention relates to filter media that filter and purify fluids, such as used cooking oils, unrefined edible oils, fruit-based and vegetable-based beverages, such as beer and wine, and biodiesel fuel. More particularly this invention relates to filter media including a top filter panel and a bottom filter panel, wherein each of the top panel and the bottom panel has a planar surface, and the top panel is in contact with the bottom panel. The top panel has at least one opening in communication with the bottom panel, whereby there is provided a controlled flow of the fluid through the top panel and the bottom panel.

Fluids such as, for example, used cooking oil, unrefined edible oils, fruit-based and vegetable-based beverages, and biodiesel fuel, may be filtered and/or purified using a filter which may be in the form of a filter pad or filter paper. The filter pad or paper, in some embodiments, may be part of a filter envelope. In some cases, the filter pad or filter paper may be impregnated with at least one adsorbent material, which may be in the form of a powder, that removes impurities from the fluid.

For example, U.S. Pat. Nos. 6,312,598 and 6,482,326 disclose a filter envelope for removing impurities from a fluid, such as used cooking oil. The filter envelope includes a filter pad and a filter paper which enclose a metal spacer grid. The filter pad has a greater permeability than the filter paper, whereby the flow of the used cooking oil is directed to the filter pad. The filter pad and filter paper are formed from cellulosic fibers. The filter pad is impregnated with magnesium silicate, whereby the magnesium silicate is contained within the fiber matrix of the filter pad, and the magnesium silicate removes impurities from the used cooking oil as it passes through the filter pad.

U.S. Pat. Nos. 5,143,604; 5,330,638; 5,354,455; and 5,449,469 disclose a rectangular filter pad that may be formed with a bumpy surface in order to increase the total surface area for removal of larger contaminants.

The filter pads described in the above-mentioned patents, however, are susceptible to being plugged or fouled by solid impurities, each as, for example, solid pieces of food when used cooking oil is filtered. Such solid impurities accumulate on the surface of the filter pad, whereby the flow of the fluid through the filter pad is impeded, and/or there is insufficient contact of the fluid with any adsorbent purifying materials which may be present on or in the filter pad.

It therefore is an object of the present invention to provide a filter that has a longer filter life before plugging or fouling and allows for controlled flow of the fluid through the filter.

In accordance with an aspect of the present invention, there is provided a medium for filtering a fluid. The medium comprises a top filter panel and a bottom filter panel. Each of the top filter panel and the bottom filter panel has a planar surface, and the top filter panel is in contact with the bottom filter panel. The top filter panel has at least one opening in communication with the bottom filter panel such that the filter medium provides for controlled flow of the fluid through the top panel and the bottom panel.

In a non-limiting embodiment, at least one of the top filter panel and the bottom filter panel is impregnated with at least one adsorbent material for removing impurities from the fluid. Thus, the filter medium provides for controlled flow of the fluid through the filter and the at least one adsorbent material impregnated in the top filter panel and/or the bottom filter panel.

In a non-limiting embodiment, the top panel is impregnated with the at least one adsorbent material. In another non-limiting embodiment, the bottom panel is impregnated with the at least one adsorbent material. In yet another non-limiting embodiment, each of the top panel and the bottom panel is impregnated with the at least one adsorbent material.

Adsorbent materials with which the filter may be impregnated include, but are not limited to, magnesium silicate, magnesium aluminum silicate, calcium silicate, sodium silicate, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomite, alkaline earth metal hydroxides, alkaline earth metal oxides, alkali metal carbonates, alkali metal bicarbonates, alkaline earth metal carbonates, alkali metal silicates, perlite, diatomaceous earth, and combinations thereof.

In a non-limiting embodiment, the at least one adsorbent material is magnesium silicate. Non-limiting examples of magnesium silicate adsorbents which may be employed are described in U.S. Pat. Nos. 4,681,768; 5,006,356; 5,597,600; 7,635,398; 9,295,810; and 10,563,150, the contents of which are incorporated by reference.

The at least one opening in the top filter panel may have a variety of shapes, including, but not limited to, circular, semicircular, oval, polygonal, including triangular (including equilateral and non-equilateral), quadrilateral (including square, rectangular, trapezoidal, parallelogram, and rhomboid), pentagonal, hexagonal, heptagonal, octagonal, and the like, as well as cross-shaped, and X-shaped, for example. Each opening has a top portion, a bottom portion, and a wall portion. In a non-limiting embodiment, the wall is formed such that the top portion of the opening has an area which is the same as that of the bottom portion of the opening. In another non-limiting embodiment, the wall is formed such that the top portion of the opening has an area which is greater than that of the bottom portion of the opening. In yet another non-limiting embodiment, the top portion of the opening has an area which is less than that of the bottom portion of the opening. It is to be understood, however, that the scope of the present invention is not to be limited to any particular shape of opening.

In a non-limiting embodiment, the top panel has a plurality of openings. In another non-limiting embodiment, the plurality of openings are arranged in a pattern having at least one row and at least one column. In yet another non-limiting embodiment, the plurality of openings are arranged in a pattern having at least two rows and two columns.

In a non-limiting embodiment, the at least one opening should have a volume that provides for controlled flow of the fluid through the top and bottom panels of the filter medium, and when the top panel and/or the bottom panel is (are) impregnated with at least one adsorbent material, to provide for controlled flow of the liquid through the at least one adsorbent material impregnated in the top panel and/or the bottom panel. In a non-limiting embodiment, the total volume of the at least one opening is from about 5% to about 65% of the total volume of the top panel. In another non-limiting embodiment, the total volume of the at least one opening is from about 10% to about 50% of the total volume of the top panel.

The top and bottom filter panels may be in the form of a filter pad or a filter paper. In a non-limiting embodiment, each of the top panel and the bottom panel is in the form of a filter pad. In another non-limiting embodiment, the top panel is in the form of a filter pad, and the bottom panel is in the form of a filter paper. In yet another non-limiting embodiment, the top panel is in the form of a filter paper, and the bottom panel is in the form of a filter pad. In a further non-limiting embodiment, each of the top panel and the bottom panel is in the form of a filter paper.

Each of the top panel and the bottom panel may be formed from a variety of materials which are known to those skilled in the art. In a non-limiting embodiment, each of the top panel and the bottom panel contain cellulosic fibers.

Cellulosic fibers which may be employed include, but are not limited to, those formed from wood pulp. Examples of such wood pulp which may be employed include those sold under the trade name “Regular Kraft” by Weyerhaueuser Company of Federal Way, Wash., and those sold under the trade name “Tyee Kraft”, also by Weyerhaueuser Company. In another non-limiting embodiment, the filter is formed from cellulosic fibers and a resin binder. Resin binders which may be employed include melamine-formaldehyde resins, urea-formaldehyde resins, or any number of “food grade” commercially available resins.

In a non-limiting embodiment, at least one adsorbent material is impregnated in the top panel and/or the bottom panel, whereby the at least one adsorbent material is contained within the fiber matrix of the top panel and/or the bottom panel.

In another non-limiting embodiment, each of the top panel and bottom panel is formed from cellulosic fibers and a passive adsorbent, such as, for example, diatomaceous earth or perlite, whereby the passive adsorbent is contained within the fiber matrix of the top panel and the bottom panel.

In accordance with another aspect of the present invention, there is provided a medium for filtering a fluid, which comprises a filter panel. The filter panel has a planar surface and at least one depression in the planar surface. Each of the at least one depression(s) has a depth which is less than the total depth of the filter panel. The filter medium provides for control of the fluid through the filter panel.

In a non-limiting embodiment, each of the at least one depressions is a concavity.

In another non-limiting embodiment, each of the at least one depressions has a planar floor portion and at least one wall portion. In yet another non-limiting embodiment, each of the at least one depression(s) has a planar floor portion and a cylindrical wall.

In other non-limiting embodiments, the at least one depression has a planar floor portion and may have three, four, five, six, seven, eight, or more walls. It is to be understood, however, that the scope of the present invention is not to be limited to any particular form of depression, provided that the depth of each at least one depression(s) is less than the total depth of the filter panel.

In another non-limiting embodiment, the filter panel has a plurality of depressions. In a further non-limiting embodiment, the plurality of depressions are arranged in a pattern having at least one row and at least one column. In yet another non-limiting embodiment, the plurality of depressions are arranged in a pattern having at least two rows and two columns.

In another non-limiting embodiment, the filter panel is impregnated with at least one adsorbent material for removing impurities from said fluid. The at least one adsorbent material may be selected from those hereinabove described.

The filter panel may be in the form of a filter pad or a filter paper. In a non-limiting embodiment, the filter panel is in the form of a filter pad. In another non-limiting embodiment, the filter panel is in the form of a filter paper.

The filter panel may be formed from a variety of materials which are known to those skilled in the art. In a non-limiting embodiment, the filter panel contains cellulosic fibers, such as those hereinabove described. In another non-limiting embodiment, the filter panel is formed form cellulosic fibers and a resin binder, such as those hereinabove described

In a non-limiting embodiment, the at least one adsorbent material is contained within the fiber matrix of the filter panel.

In another non-limiting embodiment, the filter panel is formed from cellulosic fibers and a passive adsorbent, such as, for example, diatomaceous earth or perlite, whereby the passive adsorbent is contained within the fiber matrix of the filter panel.

In a non-limiting embodiment, each of the at least one depression(s) has a depth which is from about 1% to about 99% of the total depth of the filter panel. In another non-limiting embodiment, each of the at least one depression(s) has a depth which is from about 10% to about 60% of the total depth of the filter panel.

### BRIEF DESCRIPTION OF THE DRAWINGS

The invention now will be described with respect to the drawings, wherein:

FIG. 1 is a perspective view of a first non-limiting embodiment of a filter medium in accordance with the present invention, in which the top filter panel is a filter pad having a plurality of circular openings, and the bottom panel is a filter pad;

FIG. 2 is a cross-sectional view of the filter medium shown in FIG. 1;

FIG. 3 is a perspective view of a second non-limiting embodiment of a filter medium in accordance with the present invention, in which the top panel is a filter pad having a plurality of circular openings and the bottom panel is a filter paper;

FIG. 4 is a cross-sectional view of the filter medium shown in FIG. 3;

FIG. 5 is a perspective view of a third non-limiting embodiment of a filter medium in accordance with the present invention, in which the filter medium is a filter pad having a plurality of depressions providing for controlled flow of fluid through the filter pad; and

FIG. 6 is a cross-sectional view of the filter medium shown in FIG. 5.

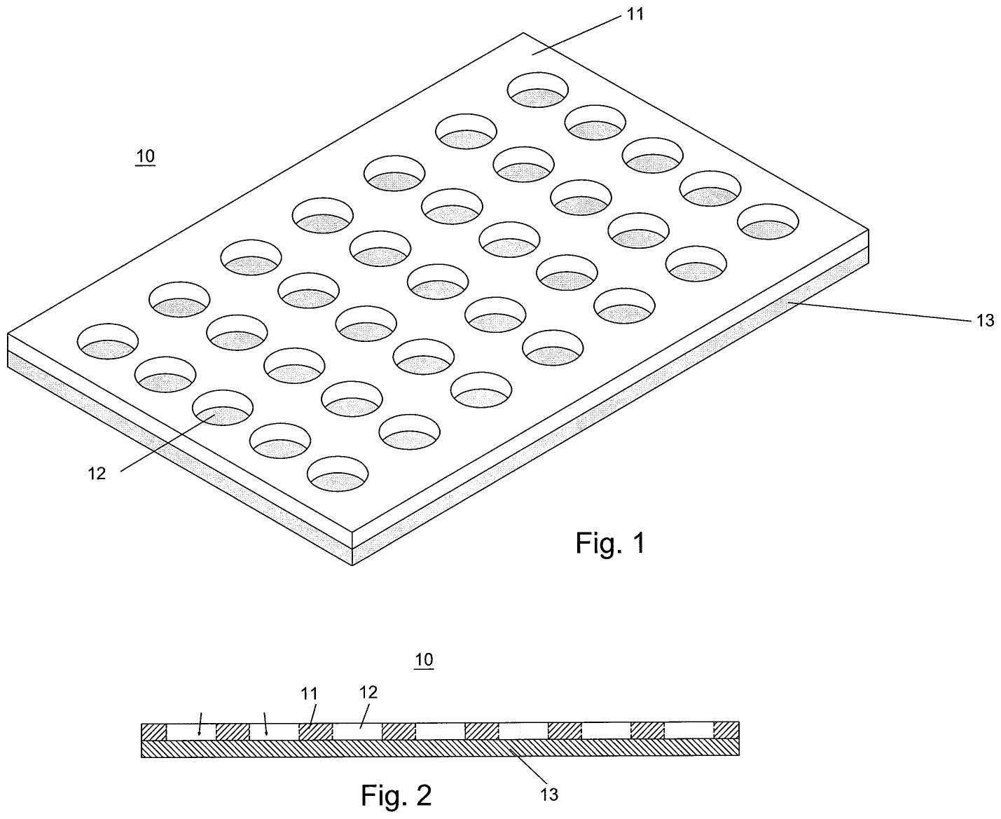

Referring now to the drawings, in a first non-limiting embodiment, as shown in FIGS. 1 and 2, filter medium 10 has a top filter pad 11, which has a planar surface and a plurality of circular openings 12, and a bottom filter pad 13. Top filter pad 11 is in contact with bottom filter pad 13, and the circular openings 12 of top filter pad 11 are in communication with bottom filter pad 13. In a non-limiting embodiment, the top filter pad 11 may be affixed to the bottom filter pad 13 by means of an adhesive. The adhesive may be any adhesive known to those skilled in the art, and which is compatible with the fluid that is to be filtered, i.e., the adhesive will not become admixed with the fluid when the filter medium 10 is contacted with the fluid. In another non-limiting embodiment, top filter pad 11 is stitched to bottom filter pad 13. The circular openings 12 are arranged in “non-staggered” rows and columns. The total volume of circular openings 12 may be from about 5% to about 65% of the total volume of top filter pad 11.

Top filter pad 11 and bottom filter pad 13 may be formed initially as flat, or planar pads from materials known to those skilled in the art, such as cellulosic fibers as hereinabove described, alone or in combination with “food grade” commercially available resin binders. Top filter pad 11 and bottom filter pad 13 also are impregnated with at least one adsorbent material that adsorbs impurities from a fluid, such as those hereinabove described.

After top filter pad 11 is formed, circular openings 12 then are formed in top filter pad 11. Such openings may be formed by methods known to those skilled in the art, such as, for example, by a hole punch or by one or more knives or other cutting, forming, or molding means. After the openings 12 have been formed in top filter pad 11, top filter pad 11 is placed on top of bottom filter pad 13 to form filter medium 10.

Filter medium 10 is used in the purification of a fluid, such as, for example, used cooking oil in order to remove free fatty acids or other impurities, or fruit-based or vegetable-based beverages, such as beer, wine, or fruit juices in order to remove chill haze components, or biodiesel fuel in order to remove impurities, such as soap, glycerides, alcohols and other impurities formed during the manufacturing process. In some cases, such as when used cooking oil is purified, the fluid may include solid materials such as particles or crumbs of food.

As top filter pad 11 is contacted with a fluid to be purified, the fluid passes through top filter pad 11, and then contacts and passes through bottom filter pad 13. A portion of the fluid passes through openings 12 of top filter pad 11, and then contacts and passes through bottom filter pad 13. As the fluid passes through top filter pad 11, openings 12, and bottom filter pad 13, the fluid contacts the adsorbent material impregnated in the top filter pad 11 and bottom filter pad 13, whereby impurities are removed from the fluid. As more fluid is passed through top filter pad 11 and openings 12, top filter pad 11 can become plugged or fouled, especially if the fluid contains solid impurities such as food particles or crumbs. Openings 12 in top filter pad 11 prevent or alleviate plugging or fouling of top filter pad 11 by collecting the solid impurities, thereby providing continued flow of the fluid through top filter pad 11 and bottom filter pad 13. Thus, filter medium 10 provides controlled flow of the fluid through top filter pad 11, bottom filter pad 13, and the at least one adsorbent material impregnated in top filter pad 11 and bottom filter pad 13.

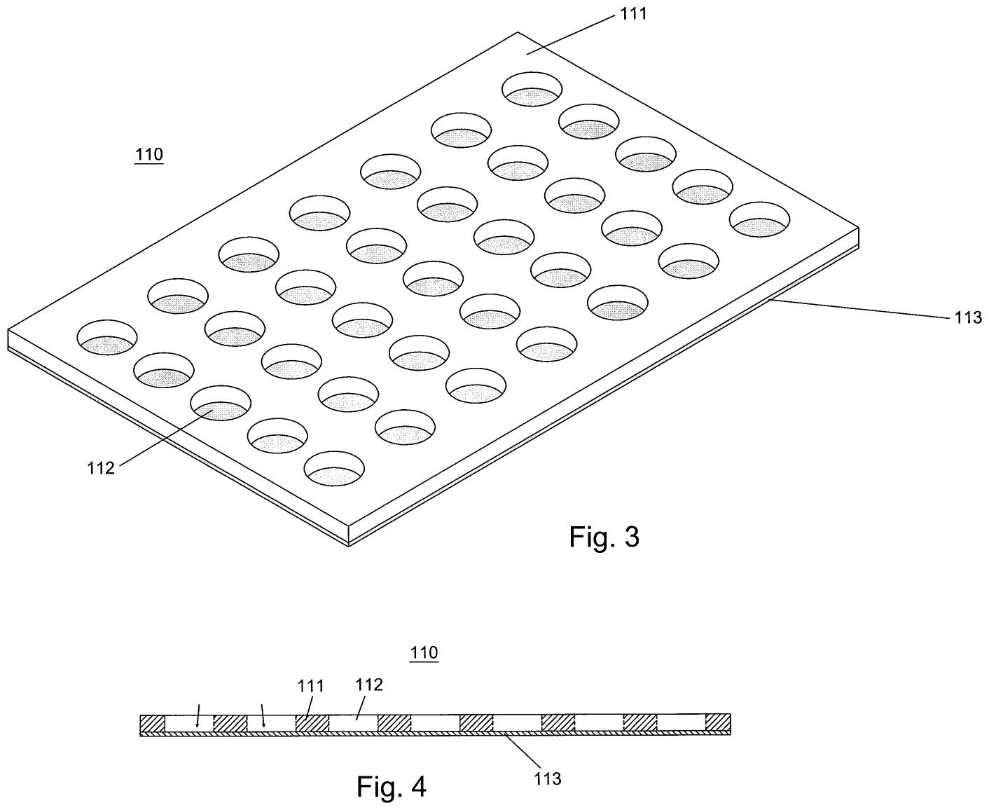

In a second non-limiting embodiment, as shown in FIGS. 3 and 4, a filter medium 110 has a top panel, which is a filter pad 111 including circular openings 112, and a bottom panel which is a filter paper 113. Filter pad 111 and filter paper 113 also are impregnated with at least one adsorbent material that adsorbs impurities from a fluid, such as those hereinabove described. Filter medium 110 is formed in essentially the same manner as filter medium 10 except that bottom filter pad 13 is replaced with a bottom filter paper 113.

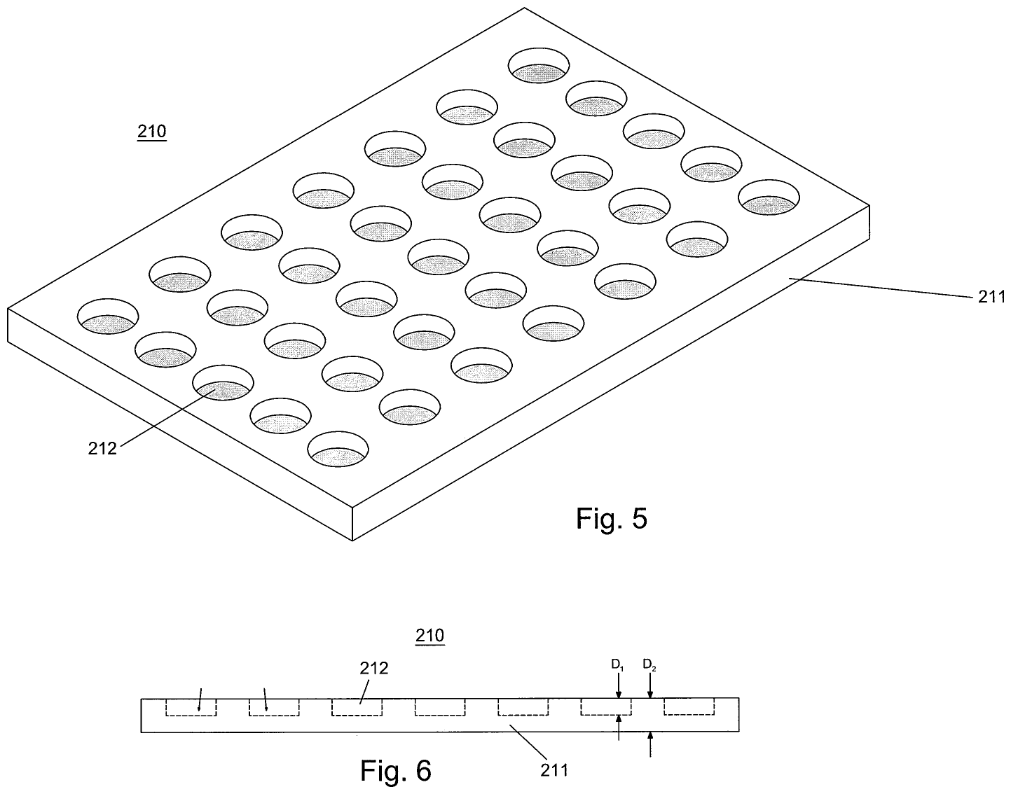

In a third non-limiting embodiment, as shown in FIGS. 5 and 6, there is provided a filter medium 210, which is a filter pad 211 including cylindrical depressions 212. Each of cylindrical depressions 212 has a depth D₁, which is less than the total depth D₂ of filter pad 211. In a non-limiting embodiment, D₁ may be from about 1% to about 99% of D₂. The depressions 212 are arranged in “non-staggered” rows and columns. Filter pad 211 also is impregnated with at least one adsorbent material that adsorbs impurities from a fluid, such as those hereinabove described.

Depressions 212 may be formed in filter pad 211 by methods known to those skilled in the art, such as, for example, a punch or by one or more knives or other cutting, forming, or molding means. It is to be understood that such means form depressions 212 in filter pad 211 such that depth of each of depressions 212 is less than the total depth of filter pad 211.

As the filter pad 211 is contacted with a fluid to be purified, the fluid passes through the filter pad 211. A portion of the fluid passes through the depressions 212 of the filter pad 211. As the fluid passes through filter pad 211 and depressions 212, the fluid contacts the adsorbent material impregnated in filter pad 211, whereby impurities are removed from the fluid. As more fluid is passed through filter pad 211 and depressions 212, the filter pad 211 can become plugged or fouled, especially if the fluid contains solid impurities such as food particles or crumbs. The depressions 212 in filter pad 211 prevent or alleviate plugging or fouling of filter pad 211 by collecting the solid impurities, thereby providing controlled flow of the fluid through filter pad 211.

The disclosures of all patents and publications are incorporated by reference to the same extent as if each patent and publication were incorporated individually by reference.

It is to be understood, however, that the scope of the present invention is not to be limited to the specific embodiments described above. The invention may be practiced other than as particularly described and still be within the scope of the accompanying claims.

What is claimed is:

1. A medium for filtering a fluid, said medium comprising:
a top filter panel and a bottom filter panel, wherein each of said top filter panel and said bottom filter panel has a planar surface and said top filter panel is in contact with said bottom filter panel, wherein said top filter panel has at least one opening in communication with said bottom filter panel such that said filter medium provides for controlled flow of said fluid through said top filter panel and said bottom filter panel.

2. The medium of claim 1 wherein said at least one opening has a circular shape.

3. The medium of claim 1 wherein said at least one opening has a semicircular shape.

4. The medium of claim 1 wherein said at least one opening has an oval shape.

5. The medium of claim 1 wherein said at least one opening has a polygonal shape.

6. The medium of claim 5 wherein said polygonal shape is a triangular shape.

7. The medium of claim 5 wherein said polygonal shape is a quadrilateral shape.

8. The medium of claim 7 wherein said quadrilateral shape is a rectangular shape.

9. The medium of claim 8 wherein said rectangular shape is a square shape.

10. The medium of claim 1 wherein said top panel has a plurality of openings.

11. The medium of claim 10 wherein said top panel has a plurality of openings that are arranged in a pattern having at least one row and at least one column.

12. The medium of claim 11 wherein said top panel has a plurality of openings that are arranged in a pattern having at least two rows and two columns.

13. The medium of claim 1 wherein at least one of said top panel and said bottom panel is impregnated with at least one adsorbent material for removing impurities from said fluid.

14. The medium of claim 13 wherein each of said top panel and said bottom panel is impregnated with at least one adsorbent material for removing impurities from said fluid.

15. The medium of claim 13 wherein said at least one adsorbent material is selected from the group consisting of magnesium silicate, magnesium aluminum silicate, calcium silicate, sodium silicate, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomite, alkaline earth metal hydroxides, alkaline earth metal oxides, alkali metal carbonates, alkali metal bicarbonates, alkaline earth metal carbonates, alkali metal silicates, diatomaceous earth, and combinations thereof.

16. The medium of claim 1 wherein at least one of said top panel and said bottom panel contains cellulosic fibers.

17. The medium of claim 16 wherein each of said top panel and said bottom panel contains cellulosic fibers.

18. The medium of claim 1 wherein the total volume of said at least one opening of said top panel is from about 5% to about 65% of the total volume of said top panel.

19. The medium of claim 18 wherein the total volume of said at least one opening of said top panel is from about 10% to about 50% of the total volume of said top panel.

20. A medium for filtering a fluid, comprising:
a filter panel having a planar surface and at least one depression in said planar surface, wherein each of said at least one depression(s) has a depth which is less than the total depth of said filter panel, whereby said filter medium provides for controlled flow of said fluid through said filter panel.

21. The medium of claim 20 wherein said at least one depression(s) is a concavity.

22. The medium of claim 20 wherein each of said at least one depression(s) has a planar floor portion and at least one wall portion.

23. The medium of claim 22 wherein each of said at least one depressions(s) has a planar floor portion and a cylindrical wall.

24. The medium of claim 22 wherein each of said at least one depression(s) has a planar floor portion and three walls.

25. The medium of claim 22 wherein each of said at least one depressions(s) has a planar floor portion and four walls.

26. The medium of claim 20 wherein said filter panel has a plurality of depressions.

27. The medium of claim 26 wherein said plurality of depressions are arranged in a pattern having at least one row and at least one column.

28. The medium of claim 27 wherein said plurality of depressions are arranged in a pattern having at least two rows and two columns.

29. The medium of claim 20 wherein said filter panel is impregnated with at least one adsorbent material for removing impurities from said fluid.

30. The medium of claim 29 wherein said at least one adsorbent material is selected from the group consisting of magnesium silicate, magnesium aluminum silicate, calcium silicate, sodium silicate, activated carbon, silica gel, magnesium phosphate, metal hydroxides, metal oxides, metal carbonates, metal bicarbonates, sodium sesquicarbonate, metal silicates, bleaching clays, bleaching earths, bentonite clay, alumina, diatomite, alkaline earth metal hydroxides, alkaline earth metal oxides, alkali metal carbonates, alkali metal bicarbonates, alkaline earth metal carbonates, alkali metal silicates, diatomaceous earth, and combinations thereof.

31. The medium of claim 20 wherein said filter panel contains cellulosic fibers.

32. The medium of claim 20 wherein each of said at least one depression(s) has a depth which is from about 1% to about 99% of the total depth of said filter panel.

33. The medium of claim 32 wherein each of said at least one depression(s) has a depth which is from about 10% to about 60% of the total depth of said filter panel.
